(19) United States
(12) Patent Application Publication
(10) Pub. No.: US 2005/0249369 A1
(43) Pub. Date: Nov. 10, 2005

(54) Flexible frequency response shaping

(75) Inventors: Jan Angst, Horgen (CH); Hilmar Meier, Zurich (CH); Thomas Raymann, Rapperswil (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 10/839,498

(22) Filed: May 5, 2004

(51) Int. Cl. H04R 25/00

(52) U.S. Cl. 381/322; 381/324; 381/325; 381/328

(57) ABSTRACT

An acoustic filter (11) of a hearing instrument or acoustic device (1), respectively, is being detachably placed nearby or at the opening (3) for the acoustic output of the instrument or device, respectively. The filtering element (11) is made of a polymer material, a synthetic, metallic or ceramic material or a fabric-like material.

The present invention refers to a hearing or acoustic instrument and a method of reducing the contamination of the hearing or acoustic instrument.

Due to audiological reasons acoustic filters are used for different shaping of frequency responses in hearing instruments. These filters are placed in the acoustic channel, passage or tube respectively, called hook, which transmits the sound coming from the instrument to the ear and the filters are replaceable by changing the tube or acoustic channel respectively. These acoustic filters are including an acoustic resistance which mainly damps the acoustic resonance and not the mechanical one. The quality of the damping screens is not always good enough which produces variation in sound quality. In addition the filters may be designed e.g. for a specific and special acoustic spectrum or noise spectrum and therefore are not always suitable for all requirements and especially for all environmental noise conditions. In other words the filters have to be changed from time to time according to the requirements, which can only be done by changing the acoustic channel or hook respectively.

Nowadays used filters are expensive, good visible while wearing the hearing instrument and tend to clog because of cerumen and moisture coming from the ear canal. For different damping or frequency responses several acoustic channels or tubes have to be built or used respectively.

Therefore, it is a subject of the present invention to propose a solution so that the tube or channel respectively does not have to be replaced for different acoustic filtering characteristics. Furthermore, it is an additional subject to better protect the hearing instrument or acoustic device against contamination during use.

Proposed is a hearing instrument or acoustic device according to the wording of claim 1 which acoustic device includes but is not limited to active and/or passive hearing aids, hearing protection devices, earphones, headphones, etc. and furthermore a method for protection of the hearing instrument or acoustic device against contamination according to the wording of claim 8.

The hearing instrument or acoustic device according to the present invention is characterized in that the acoustic filter being detachably placed at the or near by the opening for the acoustic output of the instrument or device respectively. In other words instead of a standard filter as proposed in the today's existing hearing aid devices an exchangeable filtering element is used which can be replaceably attached e.g. to the mentioned opening for the acoustic output. This element can be molded by using e.g. a suitable polymeric material and therefore can be made of a transparent material. Of course instead of a molded element made out of a polymer material any kind of material may be used which is permeable to air. For instance sintered material can be used such as sintered metal material, sintered ceramic material or sintered fiber material in the sense of a non-woven fabric. Furthermore, rubber parts, cloth fabrics and the like may be used.

The material can be coated with a hydrophobic material or be made out of a hydrophobic material such as e.g. a hydrophobic polymer like Teflon, polyethylene or the like. Instead of using a hydrophobic material the acoustic filter such as e.g. a sintered ceramic or metal-material may be coated with a hydrophobic material such as e.g. a material based on silicon.

The hydrophobic coating or the use of a hydrophobic material does have the advantage that clogging with moisture and/or dirt is impossible, which means that the acoustic filter as an additional feature includes the protection of the hearing instrument or acoustic device respectively against contamination. In other words this filtering elements protects the acoustic instrument or receiver from being clogged with cerumen or moisture.

By proposing replaceable filtering elements it is possible to define several screens for different resonance shaping. The same frequency response shapes as with standard filters are possible, and in addition several new shapes. It's possible to design an element which goes into the acoustic channel or tube respectively, which means into the hook canal (kind of a wedge).

The filter is mainly placed between the hearing instrument or acoustic device respectively and the tube, acoustic channel or hook respectively. Other locations between the hearing instrument and the ear drum are possible moo. It is preferred to place the filter element directly on the hearing instrument as mentioned above and not rigidly placed within the tube or hook, which means for replacing the acoustic filter the tube, acoustic channel or hook respectively does not have to be replaced.

The size of the damping element or acoustic filter is not related to the diameter of the tube or hook, which transmits the acoustic sound to the ear.

The filter element can be replaced by the acoustician e.g. and while each maintenance or servicing procedure with low cost. Of course the filter element may also be replaced by the end user.

In other words by using the acoustic filtering element as proposed within the present invention it is possible to reduce logistics and costs on one side for the companies producing hearing instruments and on the other side for the person wearing a hearing instrument or acoustic device respectively. New filters can be introduced easily. Filters made of water repellent material will not clog and therefore guarantee a longer lifetime of the hearing instrument without servicing.

The invention will now be explained in more details based on design examples and with reference to the attached drawings in which:

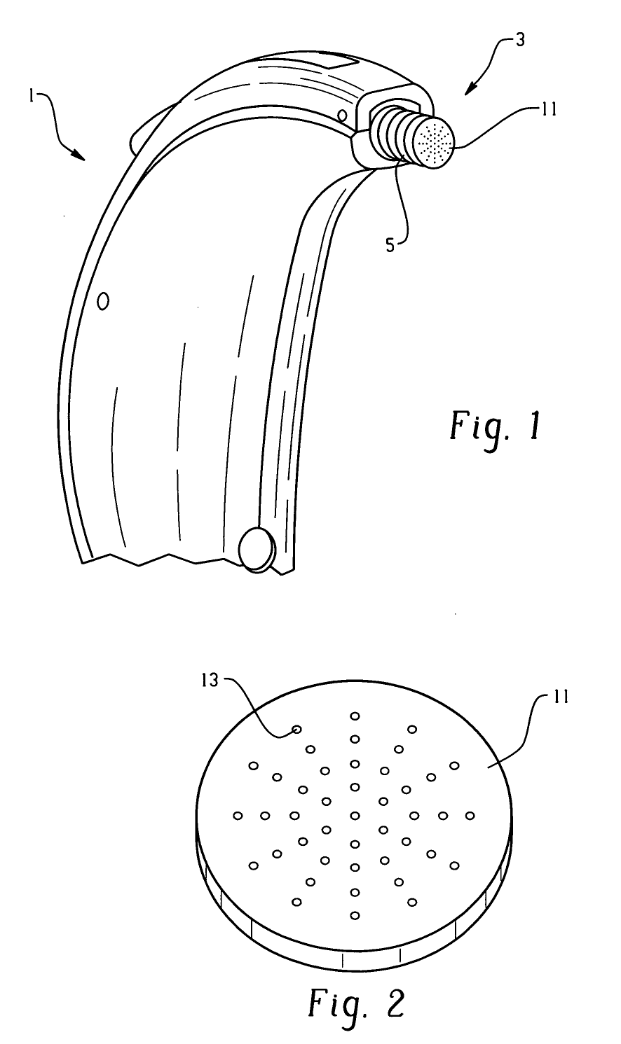

FIG. 1 shows schematically a hearing instrument with an acoustic filter placed at the acoustic output opening;

FIG. 2 in perspective view, an acoustic filtering element;

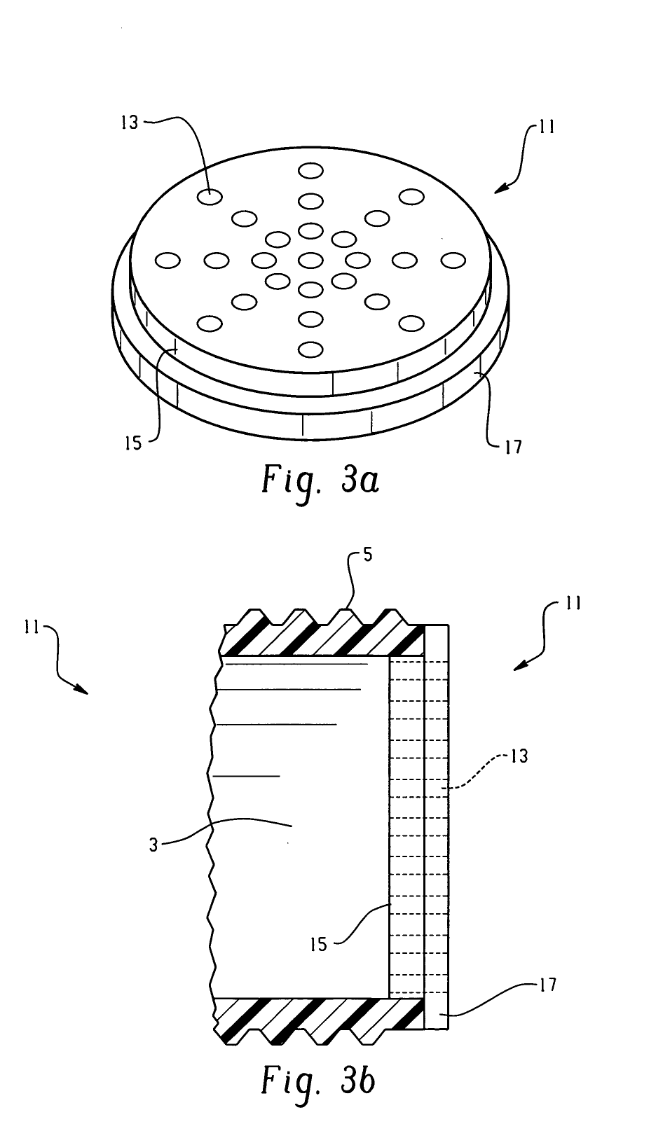

FIG. 3a a further design of an acoustic filtering element in perspective view;

FIG. 3b in a cross-section view the filtering element of FIG. 3a placed at the acoustic output opening of a hearing instrument;

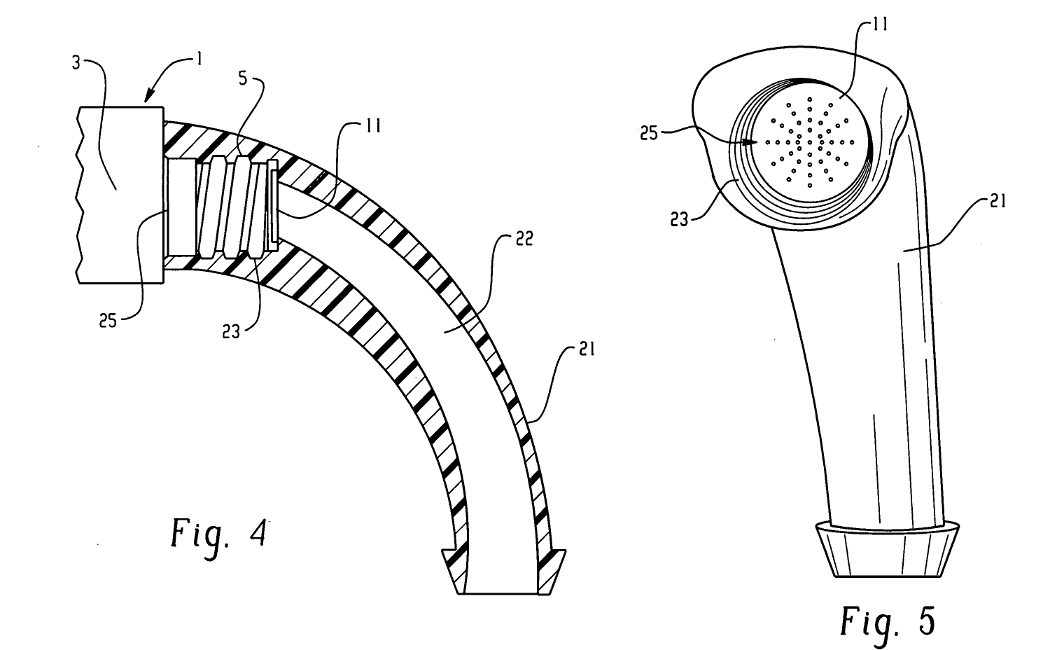

FIG. 4 in a longitudinal section view, the tube or acoustic hook element placed at the acoustic output opening showing the acoustic filtering element placed within the tube, and

FIG. 5 the filtering element placed within the tube or acoustic hook at the acoustic output opening with the hearing instrument removed for clarity.

FIG. 1 shows in perspective view a hearing instrument 1 and an acoustic output opening 3 on which as proposed according to the present invention an acoustic filtering element 11 is placed. Also shown at the acoustic opening 3 are windings 5 provided for placing a tube, acoustic channel or hook respectively to connect the acoustic instrument to the ear canal.

In FIG. 2 in perspective view the acoustic filtering element or membrane 11 is shown with the openings 13 for giving way for the sound or acoustic signals. The design of the openings 13 is responsible for the characteristics of the sound signals or acoustics respectively which is leaving the hearing instrument to the opening of the ear canal. The membrane or acoustic filtering element may be made out of a polymer material such as e.g. Teflon, polyethylene or the like or can be made out of a sintered material, such as e.g. a sintered metal or ceramic material. Furthermore, it may consist out of a sintered fabric material, such as a so-called non-woven material. Again, the design of the pores through the sintered material is responsible for the characteristics of the sound or acoustic signals leaving the hearing instrument to the opening of the ear canal.

FIG. 3a shows in perspective view a further design of the acoustic filtering element 13, which includes a collar-like section 15 perpendicularly protruding from the element and being surrounded by an annular section 17. Within the collar-like section 15 again the openings or filter pores 13 are arranged for the throughput of the acoustic signals.

FIG. 3b shows the acoustic filtering element 11 or membrane respectively attached to the acoustic output opening 3 of the hearing instrument, as shown in FIG. 1. Again, the windings 5 are visible provided for fixing a tube or hook channel for the connection of the hearing instrument to the ear canal. Of course instead of windings also other mechanical means may be provided for the connection of the hook onto the output opening as e.g. snapping elements, bayonet nut connecting means, etc. As seen in FIG. 3b the acoustic filtering element or membrane 11 respectively can easily be placed at the acoustic output opening and replaced by another element or membrane respectively if needed. For instance if another acoustic characteristic such as e.g. a different damping characteristics is needed, the element or membrane 11 respectively can be easily replaced.

In FIG. 4 in longitudinal section view the tube or hook 21 respectively is shown, which is connected to the acoustic output opening 3 of the hearing instrument 5. The tube is attached to the opening by screwing it onto the windings 5 of the opening 3. Respective windings 23 are arranged within the connection opening 25 of the tube 21. The acoustic filtering element or membrane 11 is placed between the acoustic output opening 3 of the hearing instrument 1 and the entrance into the acoustic channel 22, which transports the sound or acoustic signal to the entrance of the ear canal.

FIG. 5 shows the tube or acoustic hook 21 respectively of FIG. 4 in perspective view, the hearing instrument 1 being removed for better clarity. Again, the acoustic filtering element or membrane 11 is visible within the tube or hook 21 respectively at the entrance into the acoustic channel 22.

The drawings 1 to 5 are only showing examples and possible designs, and of course the present invention is not at all limited to the designs and the acoustic filtering elements and membranes as shown. The filtering element may be e.g. introduced within the acoustic output channel of the hearing instrument in the sense of a plug-like element, the acoustic filtering element may be a fabric-like membrane, etc. Also, different materials can be used for manufacturing the acoustic filter elements or membranes respectively. As proposed polymer materials may be used as well as sintered materials or any other suitable materials. In addition, for producing the pores or openings different methods may be used. For instance by using different sintering procedures the porous structure may be influenced. For producing pores e.g. laser beams may be used. And again it should be mentioned that the term acoustic device used throughout the present invention includes but is not limited to active and/or passive hearing aids, hearing protection devices, earphones, headphones and the like.

1. Hearing instrument or acoustic device respectively with an acoustic filter or membrane element respectively, characterized in the acoustic filtering element being detachably placed nearby or at the opening for the acoustic output of the instrument or device respectively.

2. Hearing instrument, characterized in that the acoustic filtering element is made of a polymer material, a sintered metallic or ceramic material or a fabric-like material.

3. Hearing instrument according to one of the claims 1 or 2, wherein the acoustic filtering element is made out of a hydrophobic polymer such as Teflon, polyethylene or the like and/or the openings are achievable by using a laser beam.

4. Hearing instrument according to one of the claim 1 to 3, wherein the acoustic filtering element is achievable by injection molding.

5. Hearing instrument according to one of the claims 1 to 4, wherein the filtering element is achievable by sintering fabrics or powder, grainy ceramic or metal-like material.

6. Hearing instrument according to one of the claims 1 to 5, wherein the acoustic filtering element is coated with a hydrophobic material such as e.g. a silicon-like material.

7. Hearing instrument according to one of the claims 1 to 6, characterized in that the acoustic filtering element is arranged at the interface area between the acoustic output opening of the hearing instrument and the entrance into the tube or acoustic channel within the connecting element between the hearing instrument and the entrance of the ear canal.

8. Method for protecting a hearing instrument against contamination, characterized in that a porous or openings containing acoustic filtering element consisting of a hydrophobic material and/or being coated with a hydrophobic layer is placed near to or at the acoustic output opening of the hearing instrument.

9. Method according to claim 8, wherein the acoustic filtering element is detachably placed at the acoustic output opening of the hearing instrument.
